(19) United States
(12) Patent Application Publication
(10) Pub. No.: US 2026/0251506 A1
(43) Pub. Date: Aug. 27, 2026

(54) Laser Phase Noise Measurement using Multi-Laser Interferometry and Sub-Nyquist Sampling

(71) Applicant: NEC Laboratories America, Inc., Princeton, NJ (US)

(72) Inventors: Ezra Ip, West Windsor, NJ (US); Yue-Kai Huang, Princeton, NJ (US); Fatih Yaman, Princeton, NJ (US)

(21) Appl. No.: 19/547,603

(22) Filed: Feb. 23, 2026

Related U.S. Application Data
(60) Provisional application No. 63/762,248, filed on Feb. 24, 2025.

(51) Int. Cl. G01J 9/02; H01S 3/137

(52) U.S. Cl. CPC G01J 9/02; H01S 3/137; G01J 2009/0203

(57) ABSTRACT

A method and apparatus for estimating laser phase noise power spectral density (PN-PSD) utilize multi-laser interferometry. The method performs three or more interferometric measurements and solves a matrix equation to isolate the individual noise profile of a laser of interest from reference lasers. To improve sub-Hz estimation accuracy, the invention employs a block-processing phase reconstruction algorithm that tracks instantaneous aliased beat frequencies. This enables severe sub-Nyquist sampling of beat products, significantly reducing memory requirements and allowing for longer data capture periods required for low-frequency characterization. The individual PN-PSD of each laser is obtained through digital signal processing, which may include quadratic programming to account for measurement noise

### CROSS REFERENCE TO RELATED APPLICATIONS

This application claims the benefit of U.S. Provisional Patent Application Ser. No. 63/762,248 filed Feb. 24, 2025, the entire contents of which is incorporated by reference as if set forth at length herein.

### FIELD OF THE INVENTION

The present invention relates generally to laser metrology and seismic sensing. More particularly, it pertains to a method and apparatus for characterizing the phase noise (PN) performance of stabilized lasers down to sub-Hz frequencies.

### BACKGROUND OF THE INVENTION

Stabilized lasers with low phase noise are critical for high-precision metrology and seismic applications. Conventional characterization techniques include heterodyne detection of two identical lasers and delayed self-homodyne detection. However, heterodyne detection assumes each laser contributes exactly half of the measured phase power spectral density (PSD) and delayed self-homodyne detection is highly susceptible to environmental noise and mechanical vibrations. Furthermore, stabilized lasers are costly, often making the procurement of multiple identical units for testing impractical. There remains a need for a robust, memory-efficient method to accurately estimate PN-PSD at low frequencies.

### SUMMARY OF THE INVENTION

An advance in the art is made according to aspects of the present invention directed to a method for estimating the Phase Noise Power Spectral Density (PN-PSD) of a laser of interest by performing at least three interferometric measurements using a target laser and at least two reference lasers.

Through digital signal processing, the individual PN-PSD of each laser is “unscrambled” from the composite beat products using matrix inversion or quadratic programming. Additionally, the invention introduces a block-processing phase reconstruction technique that allows for severe sub-Nyquist sampling of the interferometric products. This reduces memory requirements and enables longer data capture durations, significantly improving estimation accuracy for sub-Hz frequency ranges.

Viewed from a first aspect, an inventive method according to aspects of the present disclosure estimates the phase noise (PN) power spectral density (PSD) of a laser by performing three interferometric measurements involving the laser of interest and two reference lasers. In the absence of any other noise source, the PN-PSD of each individual laser is obtained as a matrix inversion of the PSDs of the three interferometric phases. In the general case, the inverse problem is solved as a quadratic programming problem.

Viewed from another aspect, an inventive method according to aspects of the present disclosure tracks the instantaneous frequency of the beat products as it passes different Nyquist zones, allowing correct reconstruction of the phase of the beat product without phase jumps. This enables substantial reduction in the sampling rate required on the digital sampling oscilloscope (DSO), as well as reduce memory and increase the accuracy of the estimated PN-PSD at low frequencies.

### BRIEF DESCRIPTION OF THE DRAWING

FIG. 1(A) is a schematic block diagram of an illustrative arrangement for estimating the PN-PSD of a laser using heterodyne detection of two lasers according to aspects of the present invention.

FIG. 1(B) is a schematic block diagram of an illustrative arrangement for estimating the PN-PSD of delayed self-homodyne detection according to aspects of the present invention.

FIG. 2(A), FIG. 2(B) and FIG. 2(C) are schematic diagrams of illustrative estimating phase noise PSD of three lasers by performing three interferometric measurements according to aspects of the present invention.

FIG. 3 shows illustrative block-processing-based algorithm for reconstructing the phase time-series when an interferometric beat product is highly undersampled according to aspects of the present invention.

FIG. 4(A) is a pair of plots showing illustrative PSD [X][k]² for a 4-sec block of samples taken from the beat product between two NKT lasers according to aspects of the present invention.

FIG. 4(B) is a plot showing illustrative unwrapped phase of the same 4-sec block before and after frequency shift according to aspects of the present invention.

FIG. 4(C) is plot showing illustrative reconstructed phase of a 400-sec data set using T_{win}=0.5 sec, according to aspects of the present invention.

FIG. 4(D) is a plot showing illustrative FN-PSD of the three interferometric products according to aspects of the present invention.

FIG. 4(E) is a plot showing illustrative estimated FN-PSD of the three individual lasers according to aspects of the present invention.

### DETAILED DESCRIPTION OF THE INVENTION

The following merely illustrates the principles of this disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

Unless otherwise explicitly specified herein, the FIGs comprising the drawing are not drawn to scale.

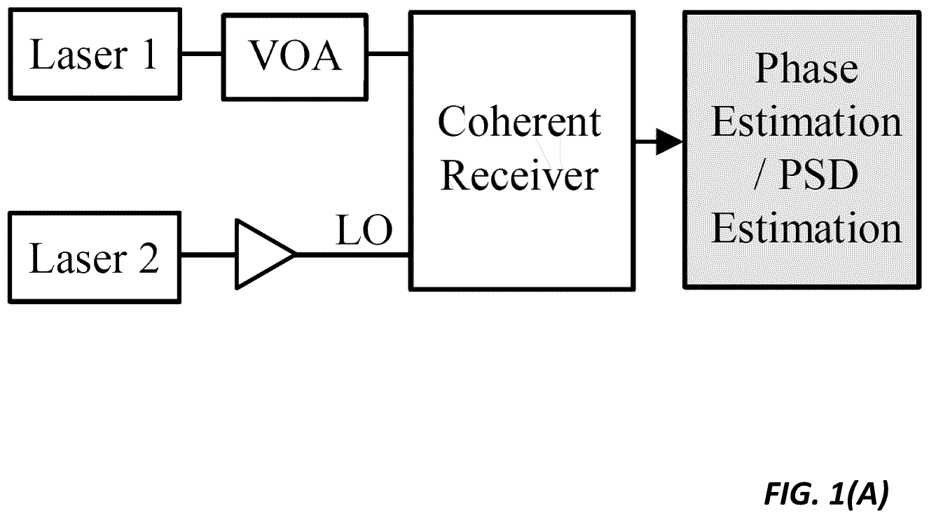

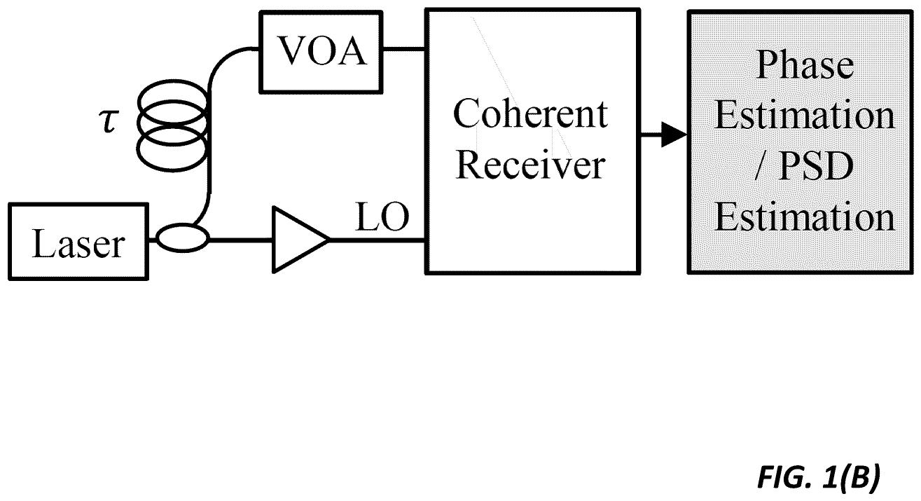

FIG. 1(A) is a schematic block diagram of an illustrative arrangement for estimating the PN-PSD of a laser using heterodyne detection of two lasers according to aspects of the present invention.

FIG. 1(B) is a schematic block diagram of an illustrative arrangement for estimating the PN-PSD of delayed self-homodyne detection according to aspects of the present invention.

As is known, stabilized lasers with low phase noise (PN) are used in metrology and seismic sensing and it is important to devise methods to characterize the phase noise performance of these lasers down to sub-Hz frequencies. A common approach is to mix two identical lasers in a coherent receiver and calculate the phase power spectral density (PSD) of their interferometric product (see, FIG. 1(A)). The drawback is that the phase PSD S_{θθ}(f)=S_{φ}_{₁}_{φ}_{₁}(f)+S_{φ}_{₂}_{φ}_{₂}(f) is the sum of the two lasers, where it must be assumed each laser contributes half of the measured PSD. Furthermore, stabilized lasers are expensive instruments, thus two lasers may not be available.

An alternative method is delayed self-homodyne detection (FIG. 1(B)), where the PSD of the delay-interferometric phase is S_{θθ}(f)=|1−e^{-j2πfτ}|²S_{φφ}(f), with τ being the delay of the decorrelation fiber. The disadvantage of this method is that the decorrelation fiber is susceptible to mechanical vibration and thermal fluctuations of the measurement setup. Furthermore, the term |1−e^{-j2πfτ}|² is a set of sinusoidal fringes with null spacing of Δf=1/τ. The null at DC will attenuate low-frequency laser PN, making the configuration susceptible to environmental noise.

With these shortcomings, it is necessary to develop a method that can accurately estimate the phase noise PSD (PN-PSD) of a laser down to low frequencies. The method should be simple, robust against environmental noise, and efficient in terms of memory requirement and digital signal processing (DSP) requirement.

An advance in the art is made according to aspects of the present invention directed to a method for estimating the Phase Noise Power Spectral Density (PN-PSD) of a laser of interest by performing at least three interferometric measurements using a target laser and at least two reference lasers.

Through digital signal processing, the individual PN-PSD of each laser is “unscrambled” from the composite beat products using matrix inversion or quadratic programming. Additionally, the invention introduces a block-processing phase reconstruction technique that allows for severe sub-Nyquist sampling of the interferometric products. This reduces memory requirements and enables longer data capture durations, significantly improving estimation accuracy for sub-Hz frequency ranges.

Disclosed is an inventive method to estimate the phase noise (PN) power spectral density (PSD) of a laser by performing three interferometric measurements involving the laser of interest and two reference lasers. In the absence of any other noise source, the PN-PSD of each individual laser can be obtained as a matrix inversion of the PSDs of the three interferometric phases. In the general case, the inverse problem can be solved as a quadratic programming problem.

Additionally, disclosed is an inventive method to track the instantaneous frequency of the beat products as it passes different Nyquist zones, allowing correct reconstruction of the phase of the beat product without phase jumps. This enables substantial reduction in the sampling rate required on the digital sampling oscilloscope (DSO), as well as reduce memory and increase the accuracy of the estimated PN-PSD at low frequencies.

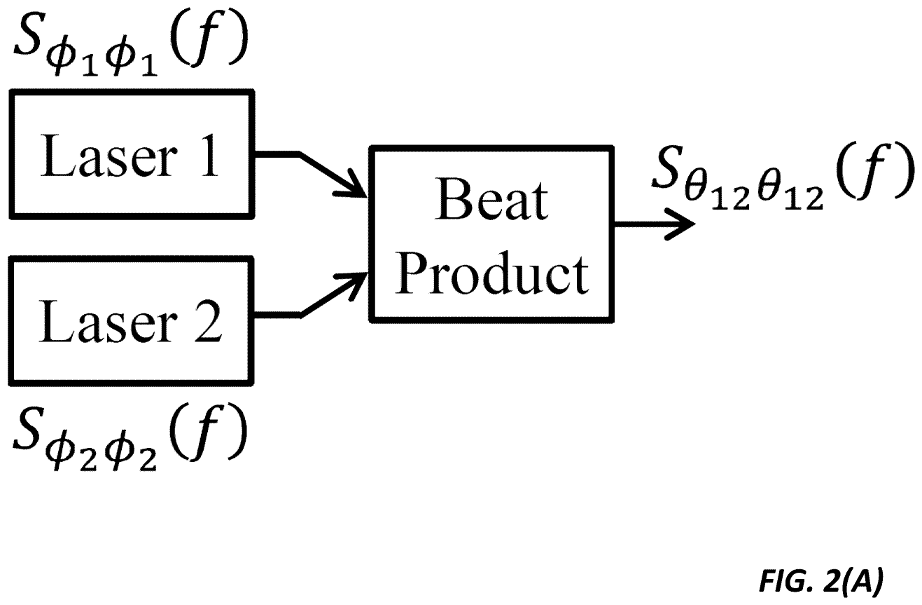

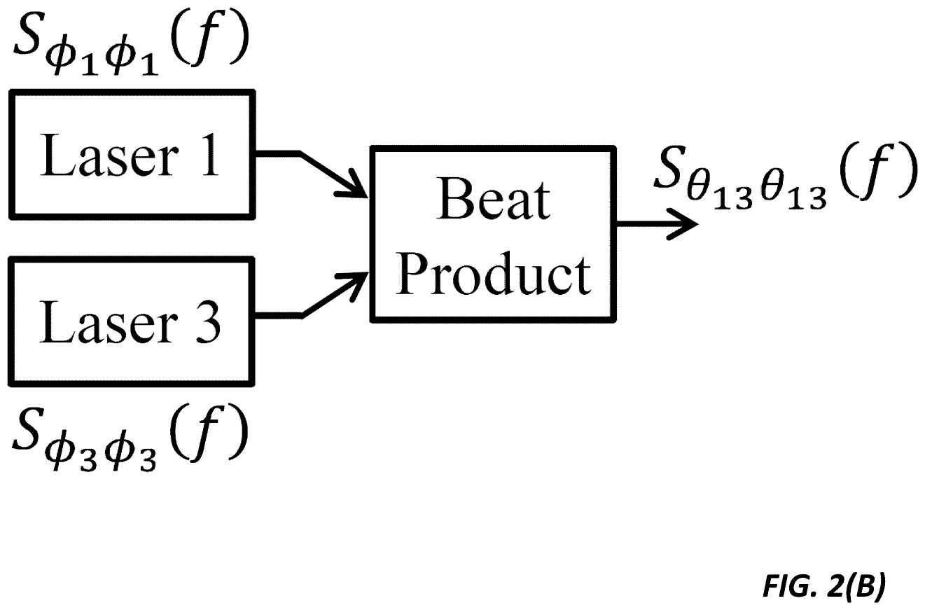

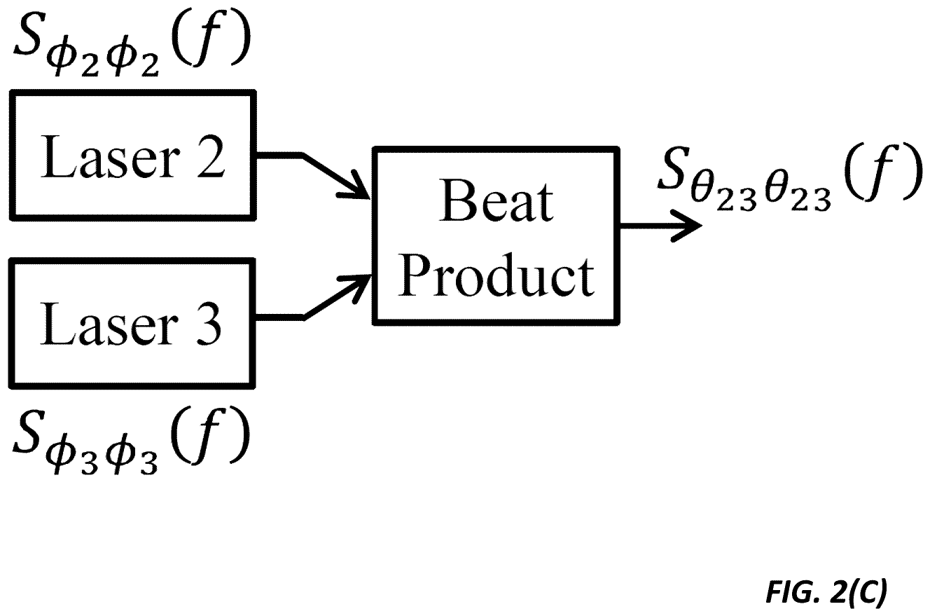

The inventive method which enables accurate estimation of the PN-PSD of a laser of interest is described by the three interferometric measurements shown in FIG. 2(A), FIG. 2(B) and FIG. 2(C), and by the quadratic programming problem presented in Equations 1 and 2.

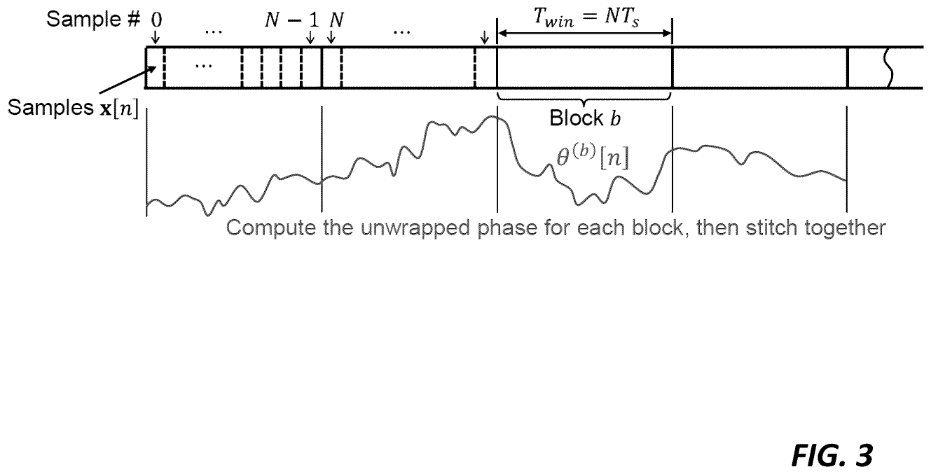

The inventive method to reconstruct the phase time-series of the beat product by tracking the aliased beat frequency of highly-undersampled interferometric products is described in FIG. 3 and Equations 3 to 5

FIG. 2(A), FIG. 2(B) and FIG. 2(C) are schematic diagrams of illustrative estimating phase noise PSD of three lasers by performing three interferometric measurements according to aspects of the present invention.

With simultaneous reference to these figures, a low-PN laser of interest (Laser 1) is compared with two higher-PN reference lasers (Lasers 2 and 3). Two lasers at a time are mixed using a coherent receiver front-end comprising a dual-polarization optical hybrid followed by balanced photodetectors. The in-phase and quadrature components of the two polarizations are sampled and digitized by a digital sampling oscilloscope (DSO).

It is assumed that the optical frequencies of the higher-PN Lasers 2 and 3 can be tuned close to that of Laser 1. We recover unwrapped phases θᵢⱼ(t)=φᵢ(t)−φᵢ(t)+φ_{n,ij}(t) of the beat product between lasers i and j. φᵢ(t) and φⱼ(t) are the PNs of the two lasers, and φ_{n,ij}(t) is measurement noise which includes phase noise from the environment (vibration and temperature fluctuations), as well as additive white Gaussian noise (AWGN) from quantum noise of the receiver and amplified spontaneous emission (ASE) of any optical amplifiers in the setup. Phase PSDs S_{θ}_{ᵢⱼ}_{θ}_{ᵢⱼ}(f) of the θᵢⱼ(t) can be calculated using periodograms. It can be shown that these are related to the PN-PSD of the individual lasers by:

$$[ \begin{matrix}{S}_{{θ}_{12} {θ}_{12}} ( f ) \\ {S}_{{θ}_{23} {θ}_{23}} ( f ) \\ {S}_{{θ}_{13} {θ}_{13}} ( f )\end{matrix} ] = [ \begin{matrix}1 & 1 & 0 \\ 0 & 1 & 1 \\ 1 & 0 & 1\end{matrix} ] [ \begin{matrix}{S}_{{ϕ}_{1} {ϕ}_{1}} ( f ) \\ {S}_{{ϕ}_{2} {ϕ}_{2}} ( f ) \\ {S}_{{ϕ}_{3} {ϕ}_{3}} ( f )\end{matrix} ] + [ \begin{matrix}{S}_{{ϕ}_{n , 12} {ϕ}_{n , 12}} ( f ) \\ {S}_{{ϕ}_{n , 23} {ϕ}_{n , 23}} ( f ) \\ {S}_{{ϕ}_{n , 13} {ϕ}_{n , 13}} ( f )\end{matrix} ] \qquad ( 1 )$$

Eq. (1) is a matrix equation S_{θθ}(f)=AS_{φφ}(f)+S_{φ}_{ₙ}_{φ}_{ₙ}(f) at each frequency f. In the absence of environmental noise, S_{φφ}(f) can be obtained by matrix inversion A⁻¹S_{θθ}(f); while in the general case, Eq. (1) is a quadratic programming problem subject to the constraint that S_{φφ}(f) cannot be negative, which can be solved using any standard method:

$${S}_{ϕ ϕ} ( f ) = {min}_{{S}_{ϕ ϕ} ( f )} {‖ {S}_{θθ} ( f ) - {AS}_{ϕϕ} ( f ) ‖}^{2} subj . {S}_{ϕϕ} ( f ) \geq 0 \qquad ( 2 )$$

A second problem is how to reconstruct the phases θᵢⱼ(t) from the complex-valued beat products. If the DSO samples at a fast enough rate greater than twice the beat frequency Δf between the two lasers, there will be no aliasing, and θᵢⱼ(t) can be obtained by phase-aligning the two polarizations, summing, and then taking the unwrapped phase. This has the disadvantage of high sampling rate and large memory requirement. The duration of the captured data will then be limited by DSO memory, causing reduced accuracy in the estimated PN-PSD at low frequencies of interest in seismic sensing.

Suppose a sub-Nyquist sampling rate Rₛ<<2Δf is used. The beat frequency Δf will be aliased to Δfₐ=Δf−kRₛ for some k where |Δfₐ|<Rₛ/2. Low-frequency laser PN manifests as Δfₐ drifting with time. We propose a block-processing-based phase reconstruction method shown in FIG. 3. Complex-valued samples are processed in blocks of N samples at the sub-Nyquist sampling interval Tₛ=1/Rₛ, where T_{win}=NTₛ is chosen so that Δfₐ does not fluctuate by more than ±Rₛ/2 within the time window with high probability. Assume the mean frequency shift

$$Δ {f}_{a}^{( b - 1 )}$$

of the previous block b−1 is known. For the current block b comprising samples with indices bN≤n<(b+1)N, we take the FFT X[k]=FFT{x[n]}, and compute the frequency centroid:

$${k}_{c} = round [ \frac{1}{2 π} ∠ ( {\sum }_{k} {\vert X [ k ] \vert}^{2} \cdot {e}^{j \frac{2 π k}{N}} ) ] \qquad ( 3 )$$

The reason for weighting |X[k]|² by

$${e}^{j \frac{2 π k}{N}}$$

is to ensure frequency index wraps continuously around the Nyquist frequency. We apply a frequency shift of

$$Δ {f}_{a}^{( b )} = ( {k}_{c} / N ) {R}_{s}$$

to the samples of block b by barrel-shifting X[k] by −k_{c}. Since the frequency-shifted signal does not cross Nyquist (±Rₛ/2), the unwrapped phase of its IFFT will be free of phase jumps:

$${\tilde{θ}}^{( b )} [ n ] = unwrap ∠ ( IFFT \{ X [ mod ( k - {k}_{c} + \frac{N}{2} , N ) - \frac{N}{2} ] \} ) \qquad ( 4 )$$

Finally, we add back the phase accumulated by the frequency shift which had been removed when calculating Eq. (4). As the frequency shift

$$Δ {f}_{a}^{( b )} - Δ {f}_{a}^{( b - 1 )}$$

between successive blocks is assumed to be within ±Rₛ/2, we set

$$Δ {f}_{a}^{( b )} = Δ {f}_{a}^{( b - 1 )} + {R}_{s} \cdot [ mod ( \frac{{k}_{c}}{N} - Δ {f}_{a}^{( b - 1 )} {T}_{s} + \frac{1}{2} , 1 ) - \frac{1}{2} ] .$$

To further ensure phase continuity between the last sample in block b−1 and the first sample in block b, we add a phase-shift of Δθ_{b}. The phase of block b is therefore:

$${θ}^{( b )} [ n ] = {\tilde{θ}}^{( b )} [ n ] + 2 πΔ {f}_{a}^{( b )} {nT}_{s} + Δ {θ}_{b} , for bN \leq n < ( b + 1 ) N \qquad ( 5 )$$

We process as many blocks 0≤b<N as necessary until the end of the data set. Note that undersampling of the beat product as proposed here will result in AWGN being aliased to within ±Rₛ/2. We assume the signal-to-noise ratio (SNR) of the beat products are high enough so that aliased AWGN does not affect the accuracy of phase reconstruction.

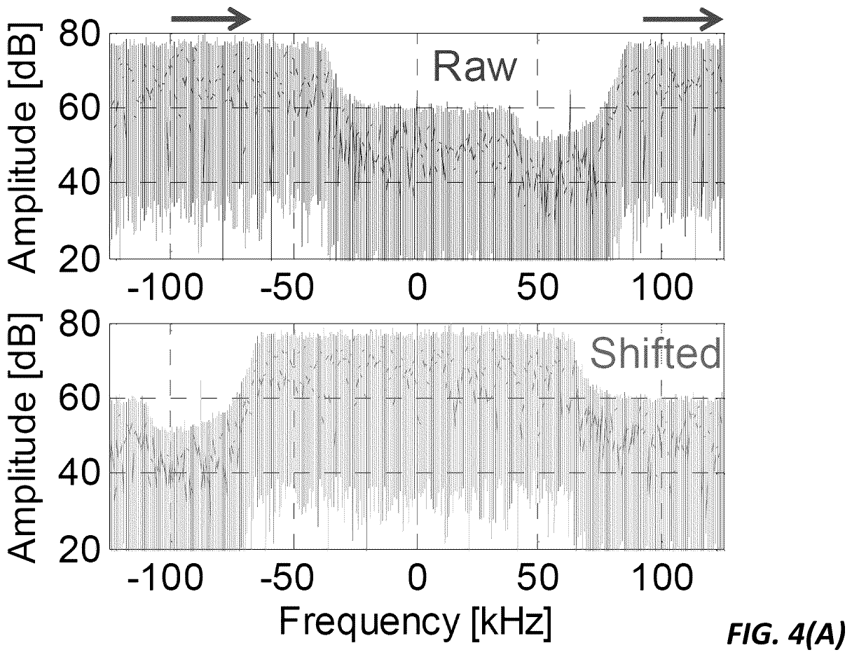

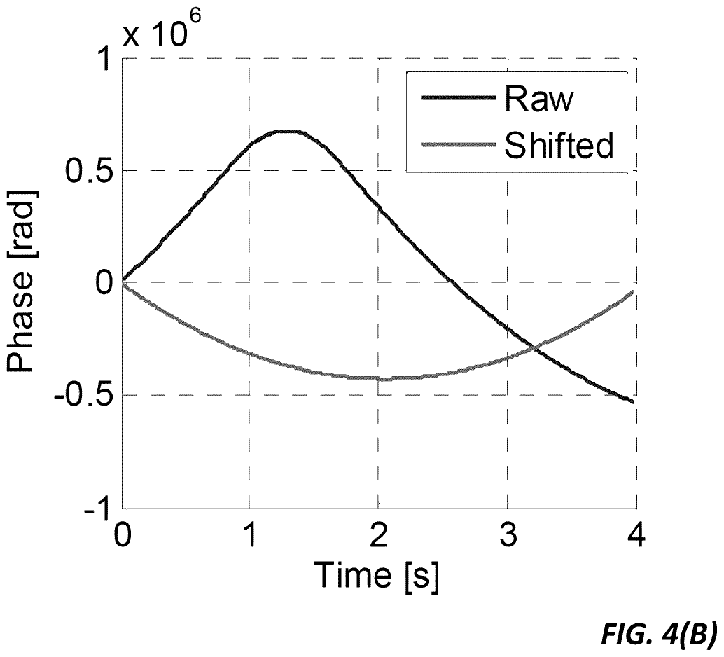

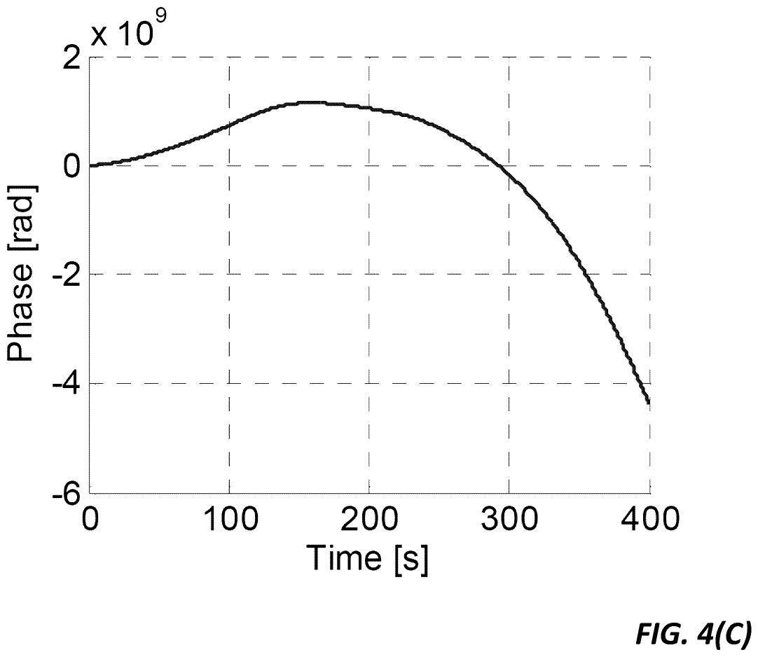

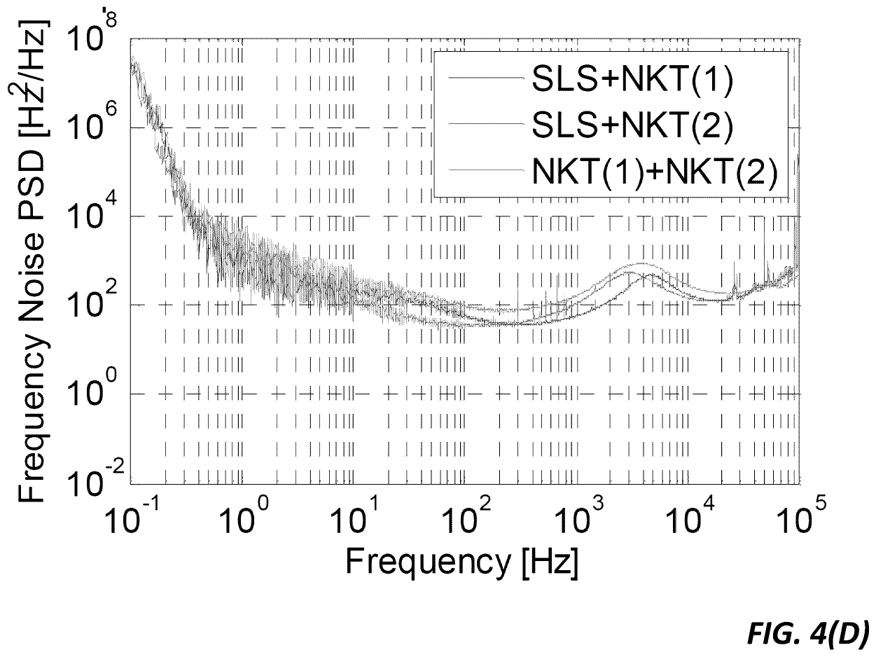

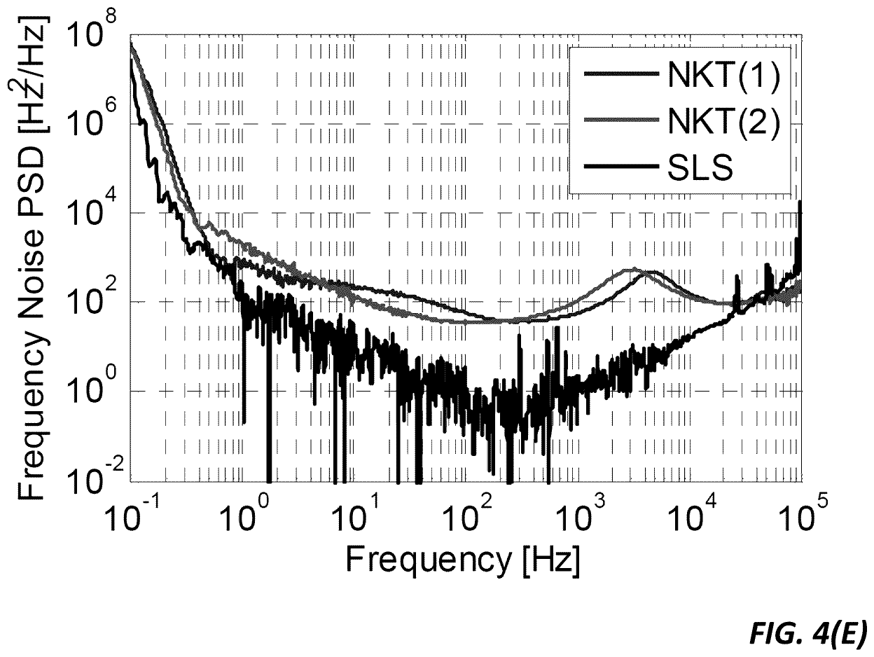

An example output of the proposed PN-PSD estimation method is shown in FIG. 4(A), FIG. 4(B), FIG. 4(C), FIG. 4(D) and FIG. 4(E).

FIG. 4(A) is a pair of plots showing illustrative PSD [X][k]² for a 4-sec block of samples taken from the beat product between two NKT lasers according to aspects of the present invention.

FIG. 4(B) is a plot showing illustrative unwrapped phase of the same 4-sec block before and after frequency shift according to aspects of the present invention.

FIG. 4(C) is plot showing illustrative reconstructed phase of a 400-sec data set using T_{win}=0.5 sec, according to aspects of the present invention.

FIG. 4(D) is a plot showing illustrative FN-PSD of the three interferometric products according to aspects of the present invention.

FIG. 4(E) is a plot showing illustrative estimated FN-PSD of the three individual lasers according to aspects of the present invention.

Shown in these figures is the arrangement in which we compared a stable laser (SLS) with two NKT X-15 fiber lasers. The SLS has an internal NKT seed laser and uses the Pound-Drever-Hall (PDH) method [5] to lock the seed laser to a mechanically & thermally stabilized, low-expansion vacuum cavity. According to the manufacturer, PN is suppressed between 10 Hz and 10 kHz. The non-stabilized NKT lasers are tunable to within ±12.5 MHz of the SLS. The DSO sampled the beat products at Rₛ=250 kHz (100× undersampling w.r.t. the maximum beat frequency range), allowing data sets of 400 sec to be captured. By trial and error, we found that T_{win}=0.5 sec was enough to ensure Δfₐ does not by drift more than +125 kHz within a block.

To illustrate beat frequency tracking, FIG. 4(A) shows |X[k]|² for a 4-sec block of samples taken from the beat product between two NKT lasers. As shown by the arrows, the beat frequency increases over the duration of the time window and drifts past the positive Nyquist frequency, but the total drift is less than 125 kHz. The frequency centroid was found to be −100 kHz.

FIG. 4(B) shows the unwrapped phase. Without frequency shifting, the beat frequency drifts past Nyquist at ~1.2 s, so phase starts to move in the opposite (negative) direction and will cause errors in the computed PN-PSD. With frequency shifting, the correct phase trajectory is preserved.

FIG. 4(C) shows the reconstructed phase for a 400-sec data set using T_{win}=0.5 sec. The frequency noise (FN) PSDs Sᵥᵥ(f)=f²S_{θθ}(f) of the three beat products averaged over 5×400-sec data sets are shown in FIG. 4(D). Using the quadratic programming outlined in Eq. 2, the recovered FN-PSD of the three lasers are shown in FIG. 4(E), confirming that PN of the SLS is >10 dB lower than the NKT lasers from 10 Hz to 10 kHz

### Extension Beyond Three Lasers

The disclosed phase noise estimation method can be extended beyond three lasers. For N lasers, it is possible to mix them in pairs in M≥N different ways using a network of optical couplers followed by photodetectors. This will result in a matrix equation at each frequency f:

$${s}_{θθ} ( f ) = {AS}_{ϕϕ} ( f ) + {s}_{{ϕ}_{n} {ϕ}_{n}} ( f ) \qquad ( 6 )$$

where S_{φφ}(f) is the N×1 vectors of the PN-PSD of the lasers, S_{φφ}(f) and S_{φ}_{ₙ}_{φ}_{ₙ}(f) are M×1 vectors of the PSDs of the beat products' phases and the environmental noises during their measurement; A is an M×N matrix. Provided rank (A)≥N, it is possible to solve for S_{φφ}(f) given S_{θθ}(f). In the absence of environmental noise, a minimum mean-square-error (MMSE) solution for S_{φφ}(f) can be found using A⁺S_{φφ}(f) where A⁺=(A*A)⁻¹A* is the Penrose pseudoinverse. In the general case, the quadratic programming problem outlined in Eq. (2) can be solved using any standard method.

At this point, those skilled in the art will understand that while we have presented our inventive concepts and description using specific examples, our invention is not so limited. Accordingly, the scope of our invention should be considered in view of the following claims.

1. A method for measuring laser phase noise power spectral density (PN-PSD), comprising:
performing at least three interferometric measurements between a laser of interest and at least two reference lasers to generate a plurality of beat products;
calculating a composite phase power spectral density for each of the plurality of beat products;
constructing a matrix equation relating the composite phase power spectral densities to the individual PN-PSDs of the laser of interest and the reference lasers; and
resolving the individual PN-PSD of the laser of interest from the matrix equation using a digital signal processor.

2. A method for reconstructing a phase time-series from an undersampled interferometric beat product, comprising:
sampling an optical beat product at a sub-Nyquist sampling rate relative to a beat frequency of the beat product;
dividing the sampled beat product into a plurality of blocks;
determining an instantaneous frequency centroid for a current block;
applying a frequency shift to the current block based on the determined frequency centroid to prevent phase jumps during unwrapping; and
stitching the plurality of blocks together by restoring an accumulated phase of the frequency shift and ensuring phase continuity between adjacent blocks.

3. The method of claim 2, wherein the sub-Nyquist sampling rate Rₛ is at least 100 times smaller than the maximum range of the beat frequency.

4. The method of claim 2, wherein the instantaneous frequency centroid determined by weighting the power spectral density of the block by a complex exponential factor to ensure continuous frequency index wrapping.

5. The method of claim 2, wherein applying the frequency shift comprises barrel-shifting the FFT of the block samples to center the signal within a Nyquist zone.

6. The method of claim 2, wherein the duration of each block is selected such that the aliased beat frequency does not fluctuate within the block duration.

7. A system for characterizing laser phase noise, comprising:
a plurality of lasers including a laser of interest and at least two reference lasers;
an optical hybrid and a plurality of balanced photodetectors configured to produce beat products from pairs of the plurality of lasers;
a digital sampling oscilloscope (DSO) configured to sample the beat products at a rate below the Nyquist limit; and
a processor configured to execute instructions to:
(i) track the instantaneous beat frequency of the sampled products to reconstruct a continuous phase time-series; and
(ii) (ii) solve a quadratic programming problem to estimate the individual PN-PSD of the laser of interest.

8. The system of claim 7, wherein the laser of interest is a stabilized laser locked to a low-expansion vacuum cavity via a Pound-Drever-Hall (PDH) method.
